(19) United States
(12) Patent Application Publication
(10) Pub. No.: US 2007/0118394 A1
(43) Pub. Date: May 24, 2007

(54) Value synthesis infrastructure and ontological analysis system

(76) Inventor: Kyle Andrew Cahoon, Warner (CA)

Correspondence Address: Kyle A. Cahoon, Box 92, Warner, AB, TOK 2L0, CA

(21) Appl. No.: 11/598,369

(22) Filed: Nov. 13, 2006

Related U.S. Application Data
(60) Provisional application No. 60/735,365, filed on Nov. 12, 2005.

(51) Int. Cl. G06Q 99/00

(52) U.S. Cl. 705/1

(57) ABSTRACT

The invention shows explicitly how direct and honest communication utilizing a distributed computing network, shared content and services, and a focus on social network dynamics and situational context can directly create experiential and realized value for all participants around the globe. Contributors (20), having instructional content to share (22) pertaining to the functional utilization of generically named goods, essentially become knowledge workers and are rewarded (26) during specific instances when commercial entity Sponsors (60), who have been granted rights through bidding in an auction (64), utilize this content to un-intrusively market their branded goods to interested and receptive Consumers (10), by having their brand names acknowledged as a valuable component of the original content. The content can also be federated with real-time calculations of statistical price information (37) and specialized data services (101) to further increase the experiential value. The Sponsors (60) participating in these niche groups can then be granted access-rights to analyze the developing value network ontology and the ongoing flow of quality information (34) among the participants in the value network.

### CROSS-REFERENCE TO RELATED APPLICATIONS

The priority to and benefit of the filing date of U.S. Provisional Patent Application Ser. No. 60/735,365 of Kyle A. Cahoon, filed Nov. 12, 2005, is hereby claimed, and the specification thereof is incorporated herein in its entirety by this reference.

### BACKGROUND OF THE INVENTION

1. Field OF Invention

This invention generally relates to methods and processes of creating reciprocal value for commercial entities and consumers of economic goods, specifically to a consumer-based value network Value Synthesis Infrastructure (VSI) and ontological analysis system.

2. Prior Art

The idea of strategically creating reciprocal value between purveyors and consumers of marketable goods and services is a new concept in the fields of marketing and business management in general.

Traditionally, means and methods of marketing products have relied on age old promotional techniques such as advertising, where advertisers create messages and storylines around a product to get and keep their brand in the mind of consumers. The advent of advertising industry in the U.S. can be trace back to the year 1841 when Volney B. Palmer started the first advertising agency in Philadelphia and other aspects of marketing such as sales promotions go back nearly as far, for instance C. W. Post issued the first manufacturers coupon in 1909. These traditional approaches to marketing worked well for advertisers and their utilization grew into mass marketing strategies as the mass media channels of national newspapers, magazines, radio and television reached wider and wider audiences.

Out of these initial approaches to marketing goods and services, came more direct and “targeted” approaches of getting to the consumer. These approaches stemmed from advertisers having access to a plethora of information about individual consumers through the utilization of powerful computers and gigantic databases. Some examples of these marketing approaches are direct mailings and telephone solicitation. Other forms are slightly more interactive, like music and movie clubs.

The emergence of the internet and the advent of email and the hyperlinked super-structure of the World Wide Web with the vast and awe inspiring achievements in communication have brought little to the table in regards to new methods of creating reciprocal value between commercial entities and their customers. In fact, the low relative cost of communication in these new media channels has resulted in marketing programs and methods that we can all live without. Everyone knows what spam is and everyone hates it in their inbox. Pop-up advertisements, spyware and malware are also very problematic. Even seemingly successful new methods of advertising, such as Google'S™ AdWordS™ search keyword advertising, it's AdSense™ contextual webpage advertising campaigns, and Kontera'S™ in-text advertising are still the old “targeted” advertising concept in a new digital format. These methods become jumbled and chaotic when mixed with the multitudes of other advertising systems on the Net as web publishers try to increase revenue on their websites.

Others have realized that the most powerful method of getting a product message across to consumers is through direct and honest communication among those whom have knowledge of the product's benefit or use and those who don't. This simple concept has been hijacked by “targeted” advertising professionals and has been mutated into hybrid concepts of “targeting by word of mouth”, “viral marketing”, and “stealth marketing” in attempts to boost the effectiveness of the concept. I have a better idea.

### BACKGROUND OF THE INVENTION—OBJECTS AND ADVANTAGES

Retailers have initiated global data synchronization programs as a way to eliminate communication errors with suppliers to increase supply chain efficiency and reduced costs. These commercial entities are also now starting to see the end consumer in a whole new light, where product quality, relationship building and reciprocal value are the focus, not simply targeted advertising. These enlightened companies, however, lack a concrete method. The platform, method, and tools to create strong relationships and reciprocal value with prospective consumers are presented in the following invention for “A Value Synthesis Infrastructure and Ontological Analysis System “, which from herein will be referred to as the VSI.

Accordingly several objects and advantages of the invention are:

a) For participating commercial entities, the VSI provides a unique way of un-intrusively marketing products and services, effectively acquiring quality business intelligence, and gaining a complete picture of individual or bundled product value propositions. The VSI facilitates business strategies to build mutually beneficial relationships with receptive pre-qualified consumers through the company's active involvement in and analysis of self-organizing niche groups and developing ontological patterns within an expanding and evolving value network.

b) For participating consumers, the VSI is a vehicle to articulate, generate, and contribute instructional content, receive remuneration for their contributions, save money from promotional incentives or group buying opportunities, and review digital receipt information on all their purchases. The instructional content and purchase data is made exponentially more socially useful and valuable to all consumers through ongoing aggregation, statistical calculations of fair value or price trends, and seamless integration with precisely germane globally synchronized product data and supplementary value-added information services.

c) The VSI, when expanded globally, can easily be intertwined with charitable initiatives to bring internet communication and wealth to the poorest regions of the earth. A person from a developing country can contribute content and receive remuneration from promotional sponsorship dollars paid from American companies to market to American consumers who are interested in instructional content contributed by the participant in the developing country.

Further objects and advantages will become apparent from a consideration of the ensuing description and drawings.

### SUMMARY

In accordance with the invention, a virtuous circle is formed through the emergence of positive network effects, development of beneficial interdependencies and correlational user empowerment within the value network. Utilizing the VSI all agents, whether labeled as Sponsors, content Contributors, or everyday Consumers of economic goods, become both consumers and contributors of valuable integrated information and services. All participants, information, services and their relationships within the VSI are dynamically connected within developing domain specific ontologies to their current role, their focused explicit interests and knowledge, their implicit collaborative contexts and concurrent activities, the germane product niches, and regional marketplaces involved within larger industry domains and the global marketplace in general.

### DRAWINGS—FIGURES

FIG. 1 is an overview of the value network showing the participants as well as the main VSI service and data components.

FIG. 2 is a diagram of a VSI Contributor and the interactive services provided to them through the VSI System.

FIG. 3 is a diagram of a VSI Sponsor and the interactive services provided to them through the VSI System.

FIG. 4 is a diagram of a VSI Consumer and the interactive services provided to them through the VSI System.

FIG. 5 is a diagram of a specific niche group instance utilizing the VSI within the value network involving a recipe Contributor, a plurality of food industry corporate Sponsors, and an everyday Consumer.

FIG. 6 is a diagram of processes of data input, collection, encoding, storage, federation, and presentation within the VSI system.

FIG. 7 is a diagram of the VSI Sponsors' auction and bidding process for trade item's GPC brick attribute or GDD functional name.

FIG. 8 is a diagram of an exemplary scenario where a consumer receives a group buy alert from the VSI Messaging Service.

### DETAILED DESCRIPTION AND OPERATION

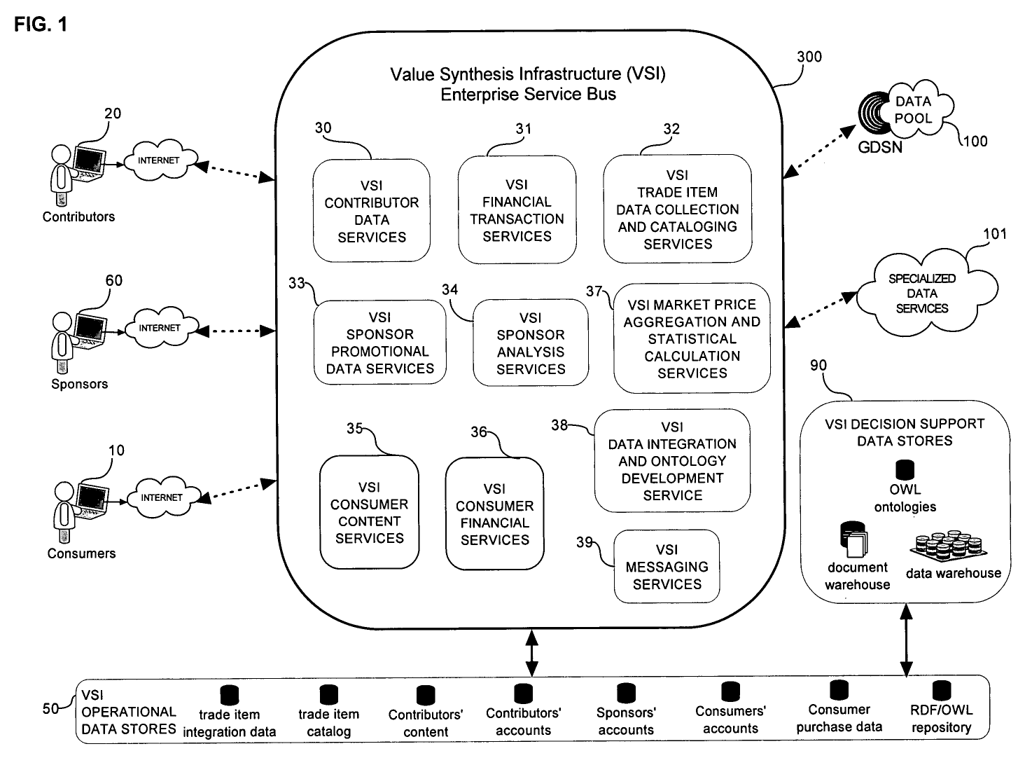

FIG. 1 is an overview of the value network showing the participants as well as the main Value Synthesis Infrastructure (VSI) service and data components. The participants in the VSI network are a global collection of Contributors 20 of instructional content, Sponsors 60 (suppliers and retailers of goods and services), and everyday Consumers 10. Participants interact with the system through rich internet applications (RIAs) which communicate with services via the enterprise service bus (ESB) 300. The ESB is composed of 10 core service components which are each composed of and interrelate with specialized sub-services. The list service components include: VSI Contributor Data Services 30, VSI Financial Transaction Services 31, VSI Trade Item Data Collection and Cataloging Services 32, VSI Sponsor Promotional Data Services 33, VSI Sponsor Analysis Services 34, VSI Consumer Content Services 35, VSI Consumer Financial Services 36, VSI Market Price Aggregation and Statistical Calculation Services 37, VSI Data Integration and Ontology Development Service 38, and VSI Messaging Services 39. The services store inputted and collected data in the VSI Operational Data Stores 50 for fast service fulfillment and all data is further stored in the VSI Decision Support Data Stores 90 for in-depth analysis. Trade item information is collected from a connection to a certified Global Data Synchronization Network (GDSN) data pool 100. The data pool may also be a component data source of the legal embodiment of the VSI. Other supplementary data may be collected from specialized data services for added informative value and language translation 101.

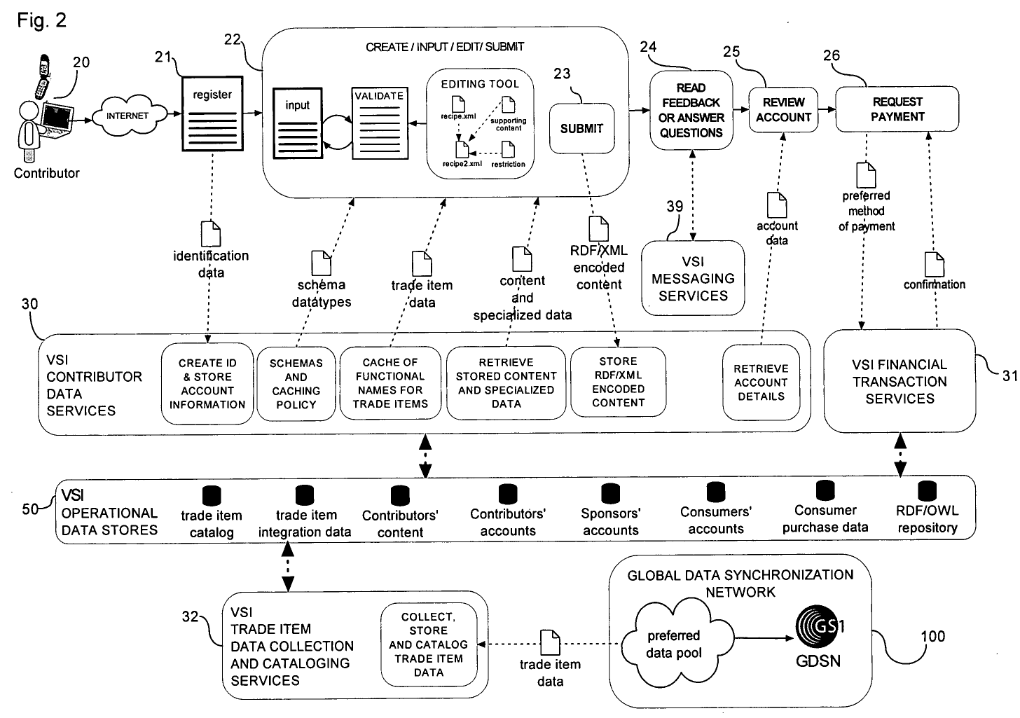

FIG. 2 is a diagram of a VSI Contributor 20 and the interactive services 30, 31 and 32 provided to them through their participation in the VSI System. VSI Contributors 20 access the VSI through a distributed computing network or telecommunications network such as the internet through a network connected device such as a computer, cellular phone, regular phone, PDA, etc. . . . The participants communicate with VSI contributor data services 30 and financial transaction services 31 by their interaction with a plurality of rich internet application interface portlets 21, 23, 24, 25, 26 which communicate extensible markup language (XML) encoded data, ensuring well-formedness and structural syntax of the data, to and from the provided services 30 and 31. The Contributor 20 first registers 21 as a participant of the network where an account and a global service relation number (GSRN) is created for them and stored in the operational data stores 50 for later identification by the VSI Contributor Data Services 30 and the VSI Financial Transaction Services 31. The Contributor 20 is now free to create input and edit instructional content of a marketable good, like goods, or related goods using the Xforms application portlet and editing toolset 22. The application may also utilize Asynchronous JavaScript and XML (AJAX) and video editing features. This application will act as a sandbox allowing the Contributor 20 to create, edit, and add supporting content before submitting the document 23 for public use. This content will comprise procedural information substantially regarding the utilization of goods, or scientifically determined knowledge, experiential knowledge, tacit knowledge, intangible knowledge, knowledge of process, method of assembly, technical know-how, artistry, screenplays, scripts, CGI or digital image metadata. For example, a certain contributor 20 may share a favorite recipe with an ingredient list and a video or audio file showing how to prepare the cuisine. The contributor 20 receives guidance in developing their content through the service's 30 xml schema constrictions and an auto-suggest feature that accesses a cache of proper functional names for trade items that have been collected and cataloged 32 from communication with a data pool (which may be incorporated into the embodiment of the VSI) of the Global Data Synchronization Network (GDSN) 100. The service 30 also retrieves their previously inputted content so the participant may edit the original content, link supporting content to their instructional content, restrict the listed trade items to certain branded products, or view specialized data that will be federated will the content when a query accesses it. When they submit 23 the content to be experienced by the general public it will be encoded with resource description framework (RDF/XML) for serialization and later RDF processing. This further allows for domain specific ontologies to be created. For example, if directions for a do-it-yourself (DIY) craft project are contributed, all the related attributes will be recorded in an RDF graph. This will included the project title, estimated time of completion, if it is suitable for a child, functional names for the required materials and tools, the contributors name or nickname, etc. . . . Contributors 20 can read feedback or answer questions 24 asked of consumers via the VSI Messaging Service 39 and then review their accounts and their sponsored earnings details 25 to see what content has been experienced and sponsored (these relations are also included in the ontology) and their total earnings. When their earnings are sufficient for a payout, they may request payment 26 via the VSI Financial Transaction Services 31.

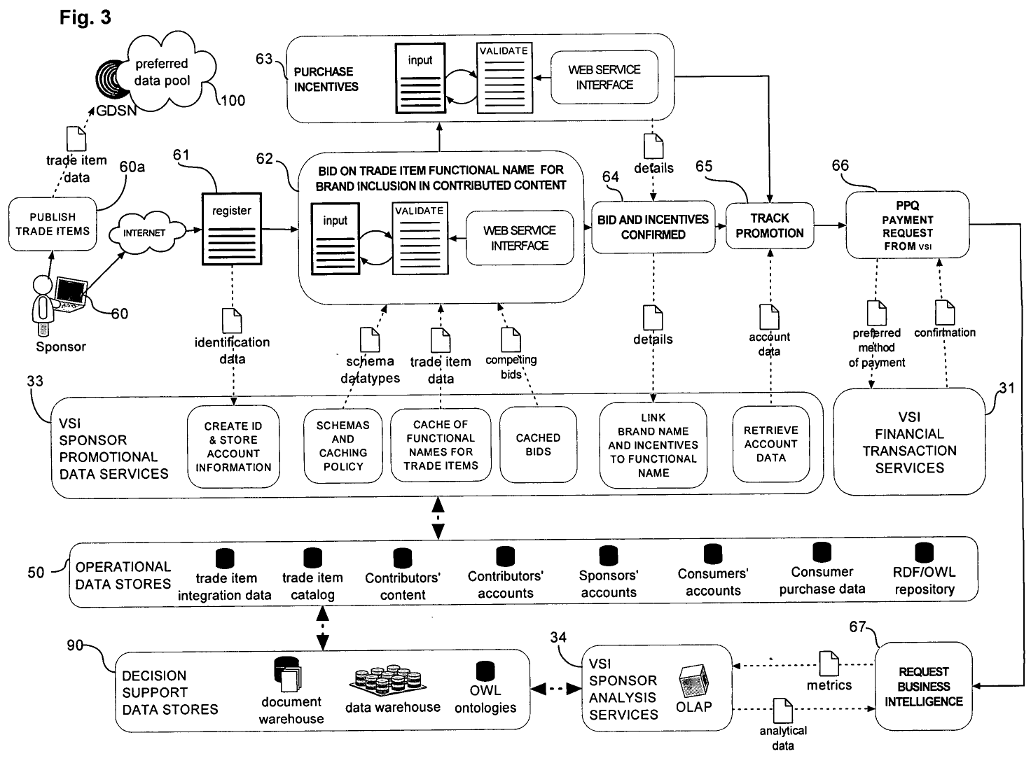

FIG. 3 is a diagram of a VSI Sponsor 60 and the interactive services provided to them through the VSI System. VSI sponsors will usually be a purveyor, supplier, manufacturer, marketer, vendor, merchant, or retailer of tangible goods, intangible goods, or service goods, consisting of a commercial entity operating within a specific industry segment, such as the food industry, hardlines (DIY) industry, or other industry domain and will have trade item data published 60a to their preferred certified Global Data Synchronization Network (GDSN) data pool 100. The GDSN 100 may also be used to notify potential Sponsors 60 that the VSI can provide them with an unprecedented marketing opportunity to acknowledge their brand and purchase incentives in quality instructional content contributed by VSI participants. Once notified a Sponsor 60 may register 61 to bid 62 for the rights of inclusion of their brand acknowledgment or purchase incentives 63 into matched contributed content and the exclusion of other brands and promotions in the same content for that particular functionally named item. The bidding process is guided through the Xforms bidding and purchase incentive application portlets 62 and 63 by communication of schema constraints and caches of trade item data and previous bid amounts through the VSI Sponsor Promotion Data Services 33. The bidding process is automated to receive via an incorporated web service. Once the bids and incentives are confirmed 64 the brand names and incentives are linked to germane content via a direct mapping with the generic functional names included in the required item lists within instructional content. The promotions can then be tracked 65 and payments are requested 66 through the VSI Financial Transaction Services 31. All data communicated in the system is encoded with XML and RDF for added structure and semantic value. A special feature of the system is the VSI Sponsor Analysis Services 34. Sponsors 60 can request quality business intelligence 67 gaining a complete picture of individual or bundled product value propositions and the self-organizing niche group instance dynamics and patterns emerging from the expanding and evolving value network of which they are active members. The Sponsor Analysis Services 34 provides an OLAP service that connects to the decision support data stores 90 document and data warehouses as well as the dynamically generated OWL ontologies database created from the RDF repository and other data within the operational data stores 50. The data may compiled and presented in graphical form utilizing scalable vector graphics (SVG).

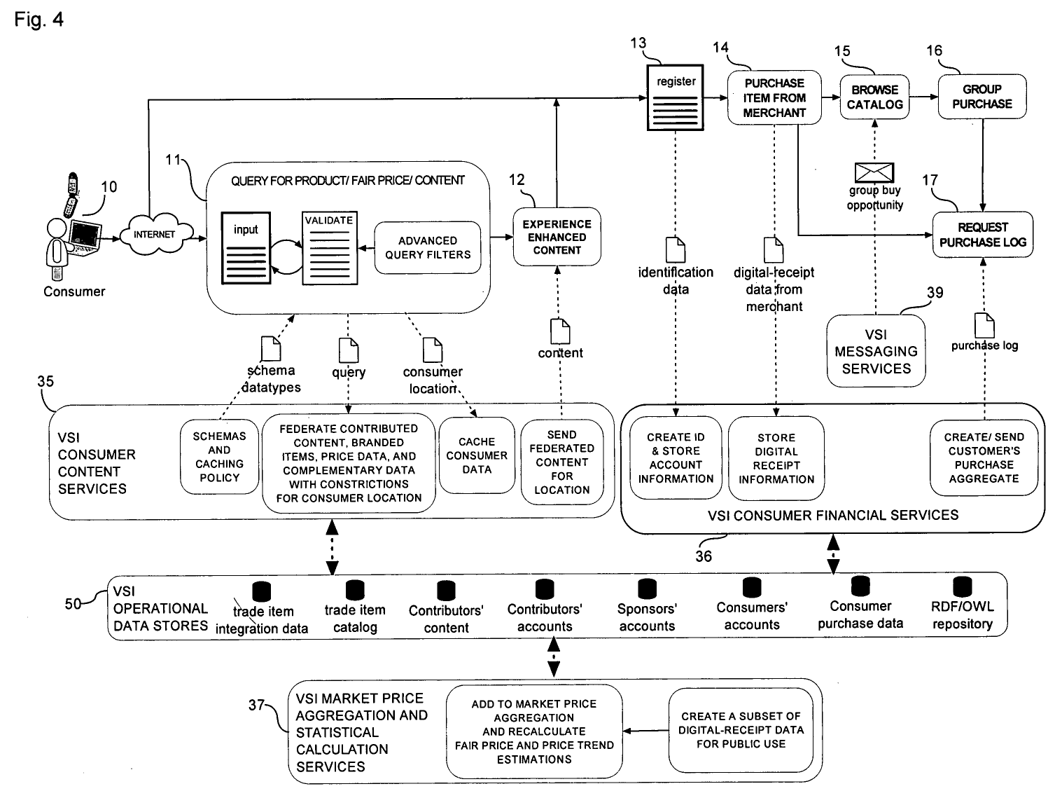

FIG. 4 is a diagram of a VSI Consumer 10 and the interactive services provided to them through the VSI System. Interested Consumers 10 can be anyone in the general public who access the VSI Consumer Content Services 35 with any kind of internet connected device and a way to experience content such as through a web browser, television channel, movie screen, etc. . . . Consumers 10 submit queries 11 to locate contributed instructional content, products, fair price or price trend estimates and to experience 12 the value of the integration of this information with complementary data and supporting content. These queries 11 could be described using text entered into an Xforms RIA form, incorporating checkbox selections, radio buttons, range, a combination of these and other controls, pre-configured query filters, and graphical representations of pre-configured filters, or simply involve channel selection or paid access to content. For example, the consumer 10 may hunger for an exotic recipe. Her query 111 could be for a desired type of cuisine or recipes containing certain foods. She may add as many levels of filtering to her query 11 as she wishes, such as health requirements (text), number of calories (integer or range), exclusion of certain foods (text), organic foods only (pre-configured filter), or vegetarian foods only (pre-configured filter graphic of an green encircled V), something a child could prepare (pre-configured filter graphic of a child), time constraints (integer or range), etc. . . . She may also have food allergies or have concerns about adverse medication and food interactions. Such a query is then guided by the systems developing domain specific ontology relating recipes and their contributors, local branded food products, their suppliers and retailers, the consumers location, and other referenced information. The consumer 10 could then receive recipe content 12 and a preparation video from a contributor in Mozambique with information on local products and purchase incentives that can be used to prepare the dish. Consumers 10 who register 13 with the VSI will receive a unique VSI global service reference number (GSRN) and experience the added benefits of the VSI Consumer Financial Services 36. These specialized services are provided to clients through a set of rich internet application portlets 15, 16, and 17. Customers who have registered 13 are provided a whole host of new and exiting services, such as a purchase log 17 where all items purchased from merchants 14 that issue digital receipt data can be reviewed and implemented in personal accounting and budgeting software programs. Nearly all retailers, especially with regard to the food industry will provide secure privacy protected digital receipt information to their customers as a value-added service in the very near future, perhaps in the form of web feeds that can be encrypted for security reasons and decrypted when reviewed by the Consumer 10 with the correct password or key. Consumers 10 who have registered 13 may also receive group buy opportunity alert messages through Extensible Messaging and Presence Protocol (XMPP) or similar technology via the VSI Messaging Services 39 as they browse the VSI catalog 15 for products. The group purchase 16 will be facilitated by the VSI and the Consumer 10 can request a purchase log 17 of all their purchases with the complete details. From all secure privacy protected digital-receipt data collected from merchants, with permission from register consumers, a subset of the data suitable for public use is retrieved and fair price and price trend estimates are then calculated via the VSI Price Aggregation and Statistical Calculation Services 37. This price data is federated with queried 11 content and trade item data, for greater informative value and a richer experience 12 for all consumers 10.

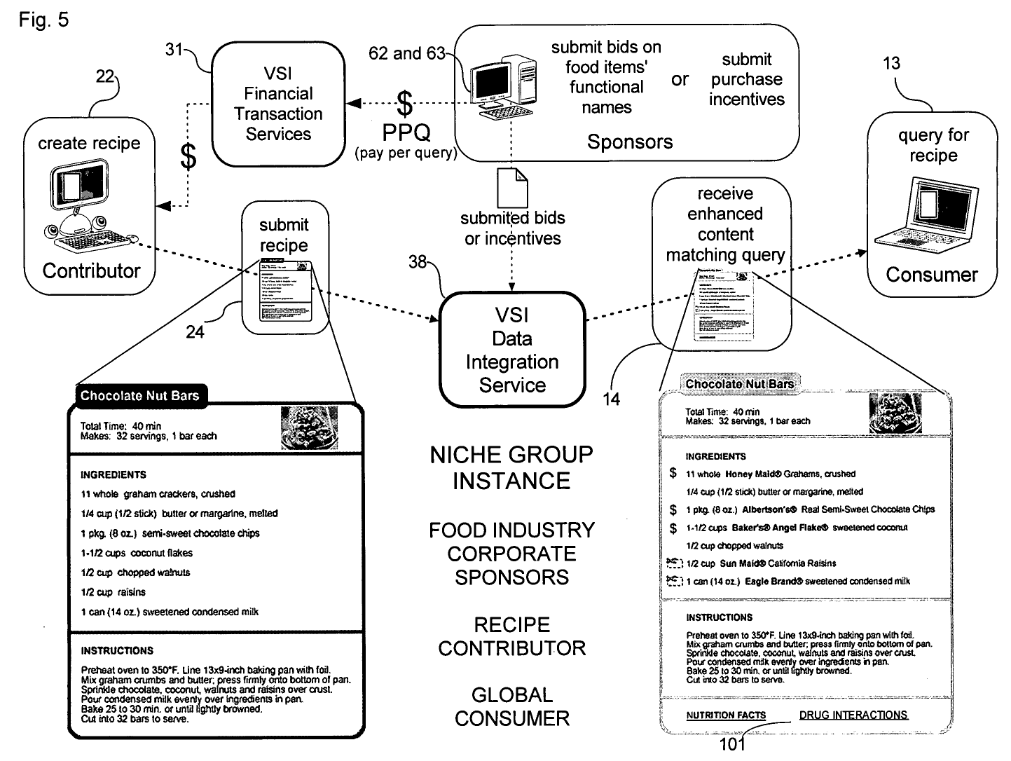

FIG. 5 is a depiction of a specific niche group instance created via the VSI within the value network and the appropriate data integration and financial transactions involved. This niche group instance comprises a recipe Contributor, several food industry corporate Sponsors, and a Consumer. The contributor has created a recipe 22 entitled “Chocolate Nut Bars”, provided photos of the dessert, and submitted the recipe 24 to the VSI. Several sponsors have also submitted bids for brand acknowledgement and purchase incentive inclusion with regard to certain food items 62 and 63 than may be contained in such a recipe. The Consumer enters a query 13 for a recipe with chocolate, coconut, and condensed milk, or a query 13 for a dessert containing chocolate chips, raisins, but not cookies, or a query 13 specifically naming a recipe for “Chocolate Bars”, or a query for new recipes from this particular contributor, etc. . . . The Consumer decides to check out the “Chocolate Nut Bars” recipe and receives the recipe federated with value-added information. The recipe ingredients, the winning bidders' brands acknowledgments and incentives, and a fair price estimate for each brand named product are federated via the VSI Data Integration Service 38 with complementary data 101 such as nutrition facts and drug interaction warnings. The data from these complementary data services 101 can also be incorporated into the original query to filter unwanted recipes from being selected. When the federated content is received by the Consumer the VSI Financial Transaction Service 31 debits the Sponsors' accounts and rewards the Contributor for contributing the tasty recipe and photos.

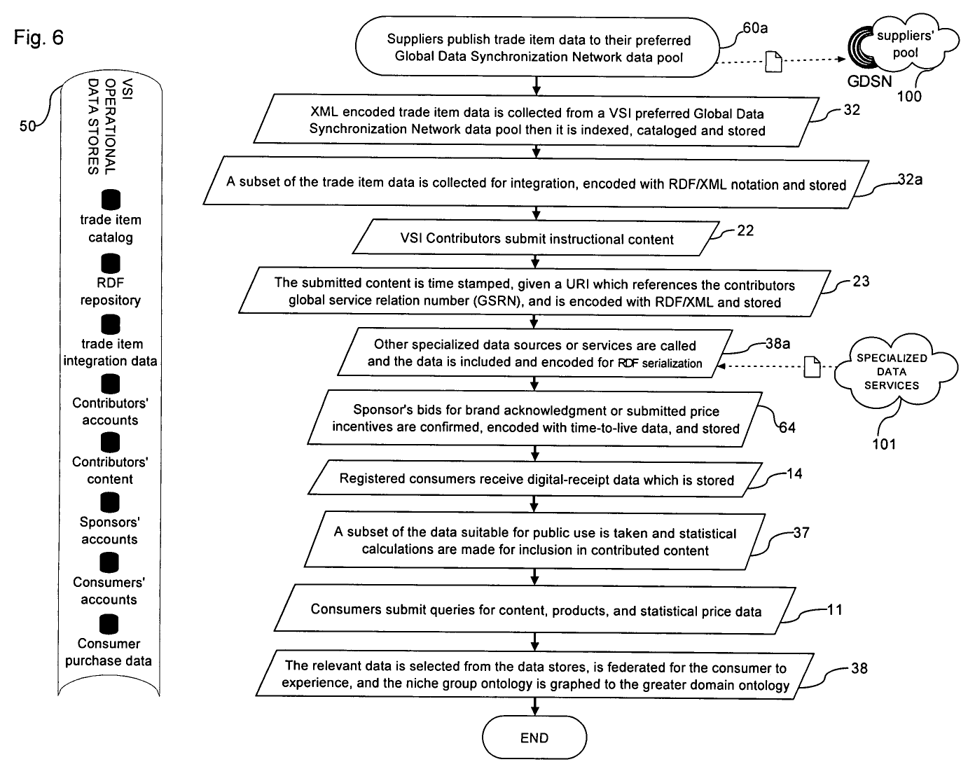

FIG. 6 is a diagram of processes of data input, collection, encoding, storage, federation, and presentation within the VSI system. The preferred embodiment of the VSI has suppliers that want to market products through the VSI, first publish their trade item data 60a to a certified GDSN data pool 100. This allows the VSI system to collect new and changing trade item information from a multitude of commercial entities from one access point. This also allows for the serialization of the information in the preferred XML encoded format for easy indexing, cataloging, and storage 32 in the VSI Operational Data Stores 50 and subsequent persistent storage within the VSI Decision Support Data Stores 90 document and data warehouses. For purposes of integration with contributed content, a subset of the trade items' description such as brand, functional name, and target market, are encoded in an RDF/XML serialization format and stored 32a for quick access. The submitted content 22 instructional document with a list of required ingredients, utensils, implements, materials, equipment, or tools used to create the specific dish, product, building, craft, product placement, and supporting content are time stamped and given reference ID's such as a Internationalized Resource Identifier (IRI); with which references the contributors global service relation number (GSRN). The content is then also encoded in the RDF/XML serialization format and stored 23. Other specialized data sources or services 101 are also called and the data to be included is encoded in RDF/XML serialization format 38a. With regard to recipes, a nutrient database is called to add relevant nutritional and caloric information to the contributed content and another database is called to add information of adverse food reactions with certain medications. Sponsors' bids for brand acknowledgement and purchase incentives are also encoded in RDF/XML; these also contain time-to-live values and explicit promotional constraints implemented at the time of confirmation 64. Participating consumers who have registered can review collected purchase logs of aggregated digital-receipt from retailers than issue secure privacy protected purchase details as a customer service 14. A subset of this data suitable for public use is taken and statistical calculations are made, such as fair price or price tend estimates, for inclusion in queried content for added informational value 37. Consumers can now submit queries for content, products, and price information 11; the response will be fast and contain accurately federated information to experience. The Xforms RIA user interface and content services with which the consumer may interact will transform consumer generated queries into an RDF or XML query language, such as SPARQL or Xquery statements for processing. The integration of the data occurs by using a Turing-complete query or document transformation language such as XML query (Xquery) or Extensible Stylesheet Language Transformation (XSLT). The disparate sources of data are mapped to each other via their explicit XML Schema element names. For example, the <ingredient> element in the recipe schema is mapped to a <functionalName> element in the trade item schema, for auto-suggestions during creation and edited by the Contributor, or to a <brandName> element in the trade item schema when brands are acknowledged and presented to the Consumer. The data is federated at the element node level of granularity where the string values containing brand names of goods are added to the document or replace the string values of generic “functional names” of products expressed in the recipe. When a qualified query is matched and the contributor's content is federated with brand acknowledgment and presented to the consumer, the consumer's location is recorded and the RDF/XML graph of niche group instance is added to the greater domain ontology 38. The RDF serialization will also include web ontology language (OWL) and reference an RDF/XML schema.

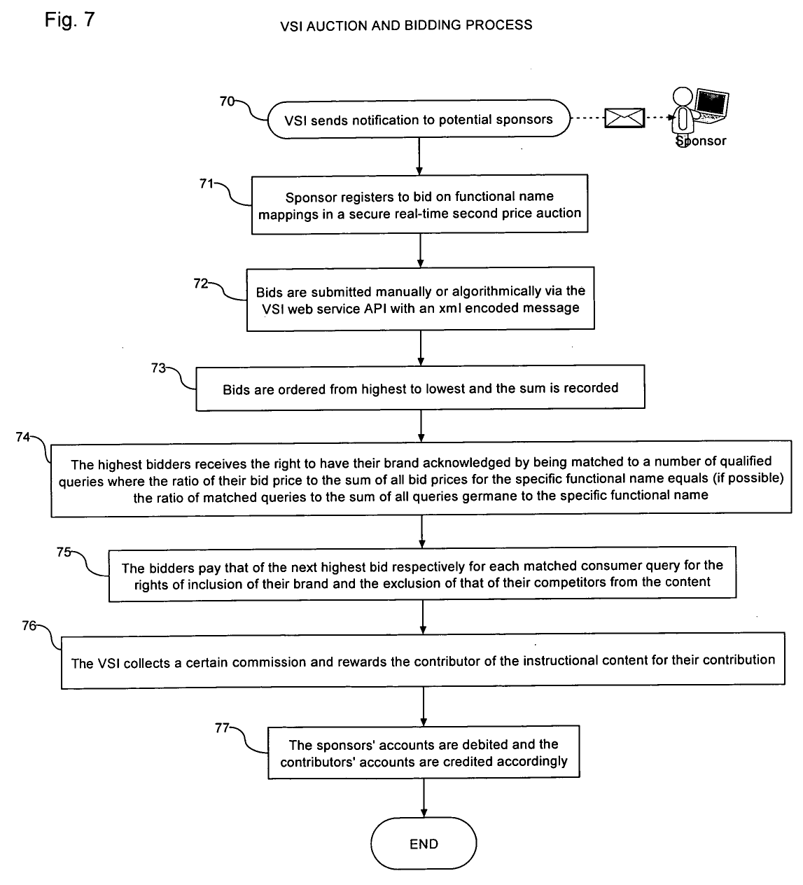

FIG. 7 is a diagram of the VSI Sponsors' auction and bidding process for trade item's global product classification (GPC) brick code or functional name element value described in the global data dictionary (GDD). The VSI sends notification to potential sponsors that their branded product names and target market may now be integrated with instructional content replacing chosen generic functional names germane to their particular products 70. Sponsor registers to bid on functional name mappings in a secure real-time second price auction 71. Bids are submitted manually or algorithmically via the VSI web service API with an xml encoded message 72. Bids are then ordered from highest to lowest and the sum is recorded 73. The highest bidders receives the right to have their brand acknowledged by being matched to a number of qualified queries where the ratio of their bid price to the sum of all bid prices for the specific functional name equals (if possible) the ratio of matched queries to the sum of all queries germane to the specific functional name 74. The bidders pay that of the next highest bid respectively for each matched consumer query for the rights of inclusion of their brand and the exclusion of that of their competitors from the content for the particular item 75. The VSI collects a certain commission and rewards the Contributor of the instructional content for their contribution 76. The Sponsors' accounts are debited and the Contributors' accounts are credited accordingly 77.

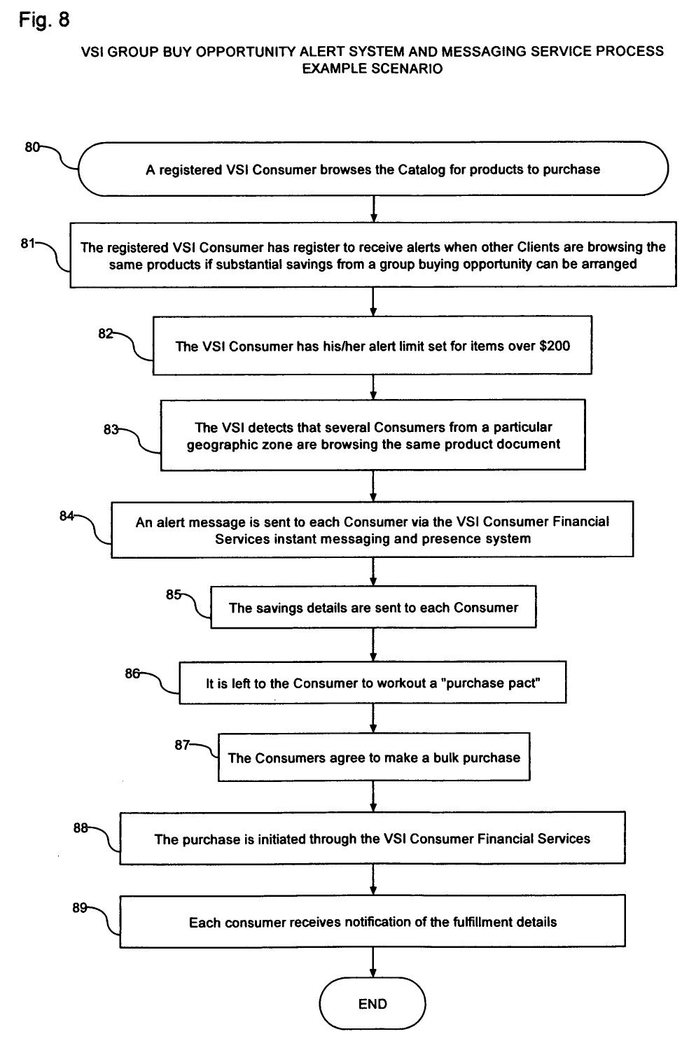

FIG. 8 is a diagram of an exemplary scenario where a consumer receives a group buy alert from the VSI Messaging Service. A registered consumer browses the catalog for products to purchase 80. The registered VSI Consumer has register to receive alerts when other Clients are browsing the same products if substantial savings from a group buying opportunity can be arranged 81. This particular VSI Consumer has his/her alert limit set 82 for items over $200.00. The VSI detects that several Consumers from a particular geographic zone are browsing the same product document 83. An alert message is sent to each Consumer via the VSI Messaging Services instant messaging and presence system 84. The savings details are sent to each Consumer 85. It is left to the Consumers to workout a “purchase pact” by a plurality of them accepting the offer 86. The Consumers agree to make a bulk-purchase 87. The purchase is initiated through the VSI Consumer Financial Services 88. Each consumer receives notification of the fulfillment details and can review their individual purchase log 89.

### CONCLUSIONS, RAMIFICATIONS, AND SCOPE

Accordingly the reader will see that, according to the VSI and ontological analysis system described, I have show that it provides a unique way for participating commercial entities to un-intrusively marketing products and services, effectively acquire quality business intelligence, and gain a complete picture of individual or bundled product value propositions. The VSI facilitates business strategies to build mutually beneficial relationships with receptive pre-qualified consumers through the company's active involvement in and analysis of self-organizing niche groups and developing ontological patterns within an expanding and evolving value network. Contributed instructional content and purchase data is made exponentially more socially useful and valuable to all consumers through ongoing aggregation, statistical calculations of fair value or price trends, and seamless integration with precisely germane globally synchronized product data and supplementary value-added information services.

While the above description contains many specificities, these should not be construed as limitations on the scope of the invention, but as exemplifications of the presently preferred embodiments thereof. Many other ramifications and variations are possible within the teachings of the invention. For example, future uses of the invention may involve automatic auction based brand placements in movies and video games with incorporated metadata or virtual reality simulations combining visual elements, tactile elements, phonetic elements, and any elements consistent with expressions of real world communication. A recipe might be tasted before it is even made. The can of soda shown in the movie might change as the movie ages or when it is shown in difference countries. The system may also be incorporated into automated ordering systems and cooking appliances.

Thus the scope of the invention should be determined by the appended claims and their legal equivalents, and not by the examples given.

I claim:

1. A value synthesis infrastructure and system providing means for creating value and ontological analysis by integrating data, content, and services shared among participants of self-organizing niche groups within an expanding and evolving value network, comprising:
(a) a distributed computing network, telecommunications network, or substantially similar communication technology,
(b) first means for creating and inputting data to said system comprising a plurality of interfaces accessible by a human, computer, or combination thereof,
(c) said data comprising elements selected from the group consisting of: presentity, textual elements, graphic symbols, visual elements, tactile elements, phonetic elements, and any elements consistent with communication,
(d) said communication comprising instances of trade information in regard to a marketable good, instructional content utilizing said marketable good, like goods having substantially the same function as said good, or related goods, or financial transaction information comprising market prices of said good, like goods, or related goods,
(e) said marketable good may refer to tangible goods, intangible goods, or service goods,
(f) said instructional content comprising that selected from the group consisting of:
(1) procedural information substantially regarding the utilization of said good, like goods, or related goods, or
(2) scientifically determined knowledge, experiential knowledge, tacit knowledge, intangible knowledge, knowledge of process, method of assembly, technical know-how, artistry, or
(3) screenplays or scripts with regard to product placement, and CGI or digital image metadata,
(g) second means for collecting said trade information in regard to a marketable good and cataloging said trade information,
(h) third means for collecting financial transaction information comprising market prices of said good,
(i) fourth means for ensuring well-formedness of said data,
(j) fifth means for reading, updating, deleting, encoding, transforming, encrypting, decrypting, storing or caching of said data on local or remote computing or digital storage devices, or any combination thereof, providing persistence and future accessibility of said data,
(k) sixth means for integrating, validating, and query processing of instances of trade information in regard to a marketable good, said instructional content, and said financial transaction information comprising market prices of said good, like goods, or related goods, said integration resulting in the improved utilization of said data and the formation of enhanced messages or content providing substantially increased informational value, semantic value, experiential value, and economic value for a multitude of said participants in said value network,
(l) said means for integrating, validating, and query processing of said data may involve direct human effort for manipulation of said data, occur automatically via said local or remote computing devices utilizing one or more central processing units invoking one or more algorithmic processes, or apply some combination thereof,
(m) sixth means providing for a plurality of said participants to experience said messages or content in a convenient format, comprising one or more of said interfaces or another disparate interface, technology, or means selected by one or more of said participants,
(n) seventh means for facilitating financial or value transactions among said participants,
(o) said participants may be legal entities, individuals, or groups of individuals, and exhibit one or a plurality of roles of participation, comprising:
(1) a purveyor, supplier, manufacturer, or marketer of said marketable good,
(2) a vender, merchant, or retailer of said good, like goods, or related goods,
(3) a competitor of one or more of the above said participants,
(4) a contributor with access to said instructional content,
(5) a sponsor of said contributor,
(6) a consumer wishing access to said information, to said knowledge, and to said messages or content,
whereby the value experienced or realized by a single participant interacting via said value synthesis infrastructure increases the value of the whole system, and therefore increases the beneficial socio-economic relationships, positive interdependencies, trust, value, and cultural awareness of and for all participants.

2. The value synthesis infrastructure and system of claim 1, wherein:
(a) said data further comprises: extensible markup language, voice xml, hypertext markup language, extensible hypertext markup language, scripting languages, extensible stylesheet language transformations, xinclude, xquery or other query processing languages, xpath expressions, resource description framework, web ontology language, relevant schemas, internationalized resource identifiers, or any similar languages or technologies, thereby substantially providing the syntax, structure, validation, integration, querying, or presentation of said data, as well as descriptions of relationships or connections among said participants, said instances of trade information, and said content, thereby further adding and incorporating dynamic ontological structure to said informational value, semantic value, and experiential value of said value synthesis infrastructure,
(b) said value synthesis infrastructure and system further comprise the usage of: native xml databases or document stores, relational databases, metadata repositories, time stamping, web caching of xml data with time-to-live values, web feeds, instant messaging, presence services, xml processing, or web services, incorporating a service orientated architecture, an enterprise service bus, web portals or any similar technologies thereby substantially providing timely communication of said messages or content, accurate integrations of said data, and statistical logs thereof, thus further adding to said informational value, semantic value, or experiential value of said value synthesis infrastructure,
(c) said instances of trade information in regard to said marketable good further include any data sourced through the global data synchronization network or similar system, comprising: global product classification brick codes and attributes, global data dictionary codes and attributes or business terms, such as: trade item or company information, global trade item number, global location number, product description attributes and values, brand, functional name, target market, contact information, other relevant information, or any combination.
(d) said instructional content further includes directions on how to create an instance of something utilizing a list of one or more items of said good, like goods, or related goods, said directions may be in print or digital format and may include elements selected from the group consisting of: text, photos, diagrams, video, audio, and any medium or means of presentation deemed appropriate by said contributor or one or more other said participants,
(e) said means for integrating, validating, and query processing of said data is further arranged to integrate and query said data at any level of granularity that is consistent with the xquery data model and extends from extensible markup language databases, document collections, individual documents, element nodes, child elements, attributes of said elements, child attribute nodes, to textual nodes in regard to semi-structured or unstructured data,
(f) said means for integrating, validating, and query processing of said data is further arranged to create a mapping between extensible markup language schema instances, element and attribute names, or values therein, of communicated extensible markup language of said trade information and said instructional content,
(g) said mapping providing for said integration or replacement of words, phrases, clauses, sentences, or subsets of data within said content with precisely germane instances of said trade information in regard to said marketable good,
(g) said means for integrating, validating, and query processing of said data is further arranged such that said query may comprise multiple queries providing added levels of filtering of said trade information, said instructional content, aggregation of said financial transaction information comprising market prices, or the federated result of said messages or content to one or more of the participants' specifications, said filtering may occur at any time before, during, or after a particular instance of said integration, validation, and query processing,
(h) said means for facilitating financial or value transactions among said participants is further arranged to allow for transfer of monies to one or more of said participants, such as said communicator, or the legal embodiment of said value synthesis infrastructure from one or more of said participants, such as said sponsor or consumer, for rights comprising:
(1) the right to participate in said value synthesis infrastructure,
(2) the right of inclusion, substantially referring to the right to include said instances of trade information in said integration of data with one or more specific instances of said instructional content of said contributor or plurality of contributors,
(3) the right of exclusion, substantially referring to the right to exclude said instances of trade information in regard to a marketable good of said competitor in said integration of data with instances of said instructional content of said contributor or said plurality of contributors,
(4) the right to experience, copy, or otherwise utilize said messages or content,
(5) the right to analyze said messages or content,
(6) the right to analyze said embodiment of said value synthesis infrastructure, or
(7) the right to analyze information regarding the formation of, the interactions of, or the network connections of said self-organizing niche group instances within said value network,
(i) said information regarding the formation of, the interactions of, or the network connections of said self-organizing niche group instances comprise that selected from the group consisting of:
(1) the number of said participants involved in a transaction,
(2) the type of said roles of participation within said transaction,
(3) public and privately protected details of said participants,
(4) the specifics of said content, said instances of trade information, or price data,
(5) the relationships and connections to other self-organizing niche group instances,
(6) timestamps,
(7) and data further illuminating significant aspects of said niche group,
wherein a snapshot is given of the context surrounding said transaction at a particular moment in time, which can be used for later review and network analysis,
whereby the total value of the system is further increased.

3. The value synthesis infrastructure and system of claim 2, wherein said means for facilitating financial or value transactions further comprises an arrangement to utilize an online auction system, said online auction system is further arranged to accept submitted bids from said sponsors for rights comprising: said right of inclusion and said right of exclusion, said submitted bids may be place for said sponsor by a human or through an automated algorithmic computing process.

4. The value synthesis infrastructure and system of claim 3, wherein:
(a) said online auction system is an augmented sealed-bid second price auction,
(b) said instances of trade information substantially refer to trade item descriptions such as: brand, functional name, and target market,
(c) said sponsors essentially bid to have their brand acknowledged within instructions on how to create an instance of something utilizing one or more items of said good, to the exclusion of competing brands in said target market,

5. The value synthesis infrastructure and system of claim 4, wherein:
(a) payments are transacted on a cost per matched query basis,
(b) such that a payment is made only when a particular query reveals said instructions that contain the functional name or the global product classification product attribute that match said marketable good in a relevant target market area, and therefore may fittingly include said brand acknowledgment,
(c) said particular query is regarded as a qualified query,
(d) said qualified query may be one of a multitude of qualified queries,
(e) said bid may also be one of a multitude of bids,
whereby the resulting content displayed for said qualified queries, the informational, semantic, and experiential value discovered therein, the addition of quality supporting content, and the efficient supply of quality products become the important focus of consideration through submitted bids on the actual named function of the product, rather than the somewhat relevant advertising garnered from bidding on multiple keywords entered into a search engine, or the screen scraped matches of internet bots.

6. The value synthesis infrastructure and system of claim 5, wherein said bids are matched to said qualified queries, now referred to as matched queries, such that said brand acknowledgment of said sponsor with the highest bid is matched to the highest number of said qualified queries, where:
(a) the ratio of the current dollar amount of said bid to the total current dollar amount of all submitted bids for said global product classification attribute or said functional name is kept as close as possible to the ratio of said matched queries to total number of said qualified queries,
(b) said ratios are algorithmically calculated on a real-time basis.

7. The value synthesis infrastructure and system of claim 2, wherein:
(a) said instructions on how to create an instance of something further comprise that of a recipe with a list of ingredients and other required equipment, implements, or utensils,
(b) said marketable good or like goods, in this case, further comprise marketable food items fulfilling the list of said ingredients,
(c) said related goods further comprise kitchen appliances, mixers, bowls, pans, whisks, utensils, or any other of said items called for in the recipe, or even cleaning supplies,
(d) said supporting content may be added at any time to improve said informational value, semantic value, or experiential value, such as a video showing preparation methods utilizing said recipe,
(e) said levels of filtering further comprise that selected from the group consisting of: desired type of cuisine, specific food usage, health requirements, number of calories, exclusion of certain foods, organic foods only, vegetarian foods only, kosher foods only, drug/food interaction data, something a child could prepare, time constraints, consumer location, and any added level selected by one or more of said participants,
(f) said specific food usage filter could be generated automatically from an inventory record of food purchases queried from an aggregate of said consumer's points of sale data or digital receipt records,
(g) said sponsors bid to include food and related items in recipes created by a multitude of said contributors for other of said participants, such as any of said consumers,
whereby said contributors receive remuneration for helping to market food and related goods, said sponsors receive a powerful new way to conduct business, and said consumers experience a valuable information resource comprising that selected from the group consisting of: tasty or useful recipes, text instructions supplemented with photos, audio, or video information, quality products used in said recipes, fair value price estimates, location, bundled savings or sales promotions, value-added services like nutritional information, drug interaction information, language translation, said levels of filtering, integration with their food purchase data, and any other added beneficial function.

8. The value synthesis infrastructure and system of claim 2, wherein:
(a) said instructions on how to create an instance of something further comprises that of a building, renovation, remodeling, landscaping, or arts and crafts project with directions and a list of required materials, equipment, implements, or tools,
(b) said good, like goods, or related goods in this case should fulfill the functional requirements of said materials, equipment, implements, or tools listed in the instructions of said project,
(c) said supporting content may be added at any time to improve said informational value, semantic value, or experiential value, such as a video showing construction methods utilizing said instructions,
(d) said levels of filtering could be based on cost, time constraints, materials on hand, or other relevant constraints,

9. The system value synthesis infrastructure and system of claim 2, further comprising means for online-analytical processing of said data, said means for analytical processing of said data is further arranged to provide:
(a) a complete picture of network influence on single and bundled products,
(b) large unbiased stratified samples of real-time high quality data, and
(c) accurate marketing performance metrics and measurements,
(d) and quality business intelligence.
whereby said purveyor, said vendor, or said sponsor can spot emerging trends and make faster strategic business decisions.

10. The value synthesis infrastructure and system of claim 9, wherein said on-line analytical processing substantially utilizes structured data, semantic web technologies, and multiple data sources, whereby real-life contextual applicability to said analysis and insight into developing ontological structures of collections of said self-organizing niche group instances can provide germane business intelligence for unique commercial entities with individual business and product goals within diverse markets and industry segments.

11. The value synthesis infrastructure and system of claim 2, wherein said participants can communicate via instant messaging or voice messaging technologies,
(a) said technologies utilize Extensible Messaging and Presence Protocol or substantially similar technology,
(b) said technology and presentity information can be further used to facilitate group buying or other financial transaction opportunities among said participants, through instant alerts that said participants share substantially similar interest in said good, like goods, or related goods, and a bulk purchase may save them money on a prospective purchase,

12. The value synthesis infrastructure and system of claim 2, wherein said participants have access to a toolset or dashboard of applications invoking services accessed through web portlets using xforms with an auto-suggest feature, javascript, scalable vector graphics, or video editing, designed to facilitate said participants interactions with said value synthesis infrastructure and system, said applications comprising planning, budgeting, accounting, creating and inputting quality content and supporting content, monitoring account activities, adding supporting content material, and additionally for commercial entities, providing a deep view of the network and gaining useful insight and analysis, said applications may require instillation on said participants computing or communications device, function as no-install rich internet applications, or support a combination thereof.

13. The value synthesis infrastructure and system of claim 2, wherein the legal embodiment of said value synthesis infrastructure either accesses instances of trade information in regard to a marketable good from a certified data pool or comprises a certified data pool of the global data synchronization network,
whereby said value synthesis infrastructure has direct access to new and updated product or company information.

14. A method of collecting financial transaction data providing increased value for personal and public usage comprising:
(a) utilizing a computer, telecommunications network or substantially similar technology,
(b) having a method of acquiring permission to securely access or transfer information of a financial transaction or instances of said data contained within said financial transaction, from one or more of a plurality of directly involved participants,
(c) repeating said method for a plurality of financial transactions of a plurality of participants selected from the group consisting of: said directly involved participants in said financial transaction and other unrelated participants directly involved in other unrelated financial transactions,
(d) accessing and transferring said information from said plurality of financial transactions and providing automatic aggregates of said information to any of said participants from any of all said transactions in which said participants were directly involved,
(e) providing for participants to experience, process, analyze, account for, budget from, or store said data of said aggregates in a network accessible personal or business financial application or where an inventory of goods purchased is beneficial,
(f) providing a method to create an aggregation of said aggregates, said aggregation may comprise a subset of said data selected from said aggregates suitable for public use, including practical details of said information comprising price paid, quantity bought, a product's global trade item number, a company's global location number, retail location, dates, or other such instances of said data while excluding duplicate information or private personal details including customer names, addresses, credit card numbers, and the like.
(g) requesting and receiving permission from a plurality of said participants to utilize said participants' aggregates of said information to obtain the subset of said data required to create said aggregation,
(h) providing value-added information or services from said aggregation comprising estimates of fair value of marketable goods, price trends, price anomalies, spending habits, market penetration, or any said value-added information or services than can be pulled from said data.
(i) providing a benefit through integration of said value-added information or services with said personal or business financial application improving utility and value of said application for said participants,
(j) providing the general public with said valuable information or services,
(k) integrating said method of collecting financial data with other data services, such as globally synchronized trade item information and shared content containing knowledge of use of said item, like items having substantially the same function of said item, or related items, in a global value network through a value synthesis infrastructure,
whereby the citizens of the world can realize the benefits of interacting in a global value network with symmetrical knowledge and more transparent pricing structure.

15. The method of collecting financial transaction data of claim 14, wherein:
(a) said data further comprises: hypertext markup languages, scripting languages, extensible markup language, query languages, resource description framework, web ontology language, relevant schemas, language translation services, or any similar languages or technologies substantially to provide the syntax, structure, validation, integration, querying, and presentation of said data, as well as descriptions of relationships or connections among said participants, said trade information, and said messages or content, thus adding to said informational value and said semantic value,
(b) said value synthesis infrastructure includes the usage of native xml databases or document stores, relational databases, file systems, web feeds, instant messaging, presence services, web services, an enterprise service bus, timestamping, or any similar technologies substantially to provide timely communication of said messages or content and accurate integration of said data, thus adding to said experiential value,
whereby said method of collecting financial data produces even more informational and semantic value for said participants and the general public.

16. The method of collecting financial transaction data of claim 15, wherein:
(a) said participants and said financial transaction comprise one or more consumers purchasing one or more items from one or more venders of goods,
(b) said venders of goods also collect points of sale data or issue digital sales receipt information,
(c) said points of sale or customer touch points have a physical location, a virtual on-line location, or a combination thereof.
(d) said consumers have granted said permission to securely access or transfer information of said points of sale or said digital sales receipt information,
(e) said aggregates of said financial transaction information may be accessed and processed with a software application, said applications may be installed on said consumers computing or communications device, function as a rich internet application, or exist as combination thereof.
(f) said aggregates of said financial transaction information are further integrated with globally synchronized trade item information and shared content containing knowledge of use of said item, like items having substantially the same function of said item, or related item utilizing said value synthesis infrastructure,
(g) a method to facilitate financial transactions is further included.

17. The method of collecting financial transaction data of claim 16, wherein said shared content containing knowledge is further comprised of that selected from the group consisting of:
(a) procedural information substantially regarding the utilization of said good, like goods, or related goods, or
(b) scientifically determined knowledge, experiential knowledge, tacit knowledge, intangible knowledge, knowledge of process, method of assembly, technical know-how, artistry, or
(c) screenplays or scripts with regard to product placement, and CGI or digital image metadata,

18. The method of collecting financial transaction data of claim 17, wherein said participants can communicate via instant messaging or voice messaging technologies, where,
(a) said technologies utilize Extensible Messaging and Presence Protocol, a presence service, or substantially similar technology,
(b) said technology and presentity information are further used to facilitate group buying or other financial transaction opportunities among said participants, through instant alerts that said participants share substantially similar interest in said good, like goods, or related goods.
